(19) United States
(12) Patent Application Publication
(10) Pub. No.: US 2026/0361702 A1
(43) Pub. Date: Nov. 12, 2026

(54) Entropy-Driven Data Fractalization and Reassembly

(71) Applicant: Darkstrike, Inc., Austin, TX (US)

(72) Inventor: David A. Granzotti, Cary, NC (US)

(73) Assignee: Darkstrike, Inc., Austin, TX (US)

(21) Appl. No.: 19/672,285

(22) Filed: May 8, 2026

Related U.S. Application Data
(60) Provisional application No. 63/802,246, filed on May 8, 2025.

(51) Int. Cl. H04L 9/40

(52) U.S. Cl. CPC H04L 63/0428

(57) ABSTRACT

A system and method for entropy-driven data fractalization and reconstruction are disclosed. Input data is transformed using recursive slicing and scrambling operations governed by a non-deterministic entropy source. In hybrid implementations, entropy-conditioned quantum gate operations encode entropy and entanglement into structured quantum states, which undergo irreversible collapse via measurement into deterministic classical representations. In classical implementations, an entropy-conditioned transformation sequence segments data into entropy-weighted fragments. A reconstruction key including deterministic metadata is generated to encode transformation lineage, structural dependencies, and entropy fingerprints. The resulting fragments, deterministic metadata, and/or reconstruction key are distributed across classical storage systems. Data reconstruction is restricted until the deterministic metadata, reconstruction key, and/or entropy parameters are validated through cross-validation or quorum-based mechanisms.

### CROSS-REFERENCES TO RELATED APPLICATIONS

This application claims priority under U.S. Provisional Application 63/802,246, filed May 8, 2025, titled “Systems and Methods for Entropy-Driven Data Fractalization and Metadata-Governed Data Reassembly Across Quantum and Classical Architectures.”

This application relates to U.S. Nonprovisional Application [Attorney Docket No. 117273-1506718-000110US], filed May 8, 2026, titled “Systems and Methods for Stateless Encryption Without Key Storage or Transmission.” That application claims priority under U.S. Provisional Application 63/802,239, filed May 8, 2025, titled “Systems and Methods for Stateless Encryption Without Key Storage or Transmission.”

This application incorporates all these by reference.

### BACKGROUND

The embodiment described here relate to the field of data security, particularly the transformation and verification of classical data using entropy-driven fractalization and cryptographically encoded metadata.

### BRIEF SUMMARY

According to at least one embodiment, a method for secure data transformation and reconstruction may include receiving an input dataset; applying a sequence of quantum gate operations based at least in part on a non-deterministic entropy source, the sequence of quantum gate operations configured to encode entropy, superposition, and entanglement into structured quantum states representing the input dataset; recursively fractalizing the structured quantum states into entropy-weighted fragments; performing a measurement operation on the structured quantum states, wherein the measurement operation irreversibly collapses the structured quantum states into deterministic classical representations; generating a deterministic reconstruction key encoding structured metadata, the structured metadata describing transformation lineage, entropy fingerprints, and structural relationships of the deterministic classical representations, wherein the deterministic reconstruction key does not preserve quantum coherence; storing the deterministic classical representations and the deterministic reconstruction key in a classical storage system; and reconstructing the input dataset using classical infrastructure by validating the entropy fingerprints and the structural relationships of the structured metadata encoded in the deterministic reconstruction key.

According to at least one embodiment, a method for secure data transformation and reconstruction using classical-only infrastructure may include receiving an input dataset; obtaining a non-deterministic entropy vector; applying an entropy-conditioned transformation sequence to the input dataset to recursively segment and non-deterministically reorder the input dataset into a plurality of entropy-weighted fragments; generating a reconstruction key encoding deterministic metadata comprising a transformation path, an entropy seed, a structural class, and a segment fingerprint for the plurality of entropy-weighted fragments; storing the plurality of entropy-weighted fragments and the deterministic metadata across one or more classical storage systems; and reconstructing the input dataset by deterministically reproducing the entropy-conditioned transformation sequence through validation of the deterministic metadata and the non-deterministic entropy vector.

According to at least one embodiment, a system for entropy-conditioned data fractalization and reconstruction may include an entropy ingestion module configured to receive a non-deterministic entropy input from a non-deterministic entropy source; a fractalization engine configured to recursively segment and non-deterministically order input data into a plurality of fragments based on parameters derived from the non-deterministic entropy input; a metadata generator configured to generate a deterministic reconstruction key comprising metadata that encodes a transformation pathway, structural dependencies, and an entropy fingerprint associated with the plurality of fragments; a storage controller configured to route the plurality of fragments and the deterministic reconstruction key to one or more classical storage locations; and a reconstruction engine configured to reconstruct the input data by cross-validating the deterministic reconstruction key against the non-deterministic entropy input, wherein any mismatch causes the reconstruction to abort.

### BRIEF DESCRIPTION OF THE DRAWINGS

FIG. 1 is a flowchart illustrating an overview of the hybrid architecture for quantum computation and classical storage, according to at least one embodiment.

FIG. 2 is a block diagram illustrating a system for entropy-conditioned data fractalization and reconstruction, according to at least one embodiment.

FIG. 3 is a diagram illustrating a quantum gate flow including Hadamard, CNOT, and QFT gates, according to at least one embodiment.

FIG. 4 is a flowchart illustrating the classification logic for quantum measurement collapse, according to at least one embodiment.

FIG. 5 is a block diagram illustrating a QRNG entropy injection mapping, according to at least one embodiment.

FIG. 6 is a flowchart illustrating a classical verification and reassembly workflow using stored metadata, according to at least one embodiment.

FIG. 7 is a flowchart illustrating a method for secure data transformation and reconstruction, according to at least one embodiment.

FIG. 8 is a flowchart illustrating a method for secure data transformation and reconstruction using classical-only infrastructure, according to at least one embodiment.

### DETAILED DESCRIPTION

Modern digital infrastructure relies heavily on conventional cryptographic protocols to secure data at rest and data in transit. Algorithms such as the Rivest-Shamir-Adleman (RSA) cryptosystem and Elliptic Curve Cryptography (ECC) derive their security from the computational complexity of mathematical operations, such as prime factorization and discrete logarithms. While these complexity-theoretic security models provide robust protection against classical computing architectures, the continuous advancement of quantum computing introduces new computational paradigms. Specifically, quantum algorithms, such as Shor's algorithm, possess the theoretical capability to resolve these mathematical complexities in polynomial time. Consequently, existing cryptographic frameworks may not fully address long-term security considerations in a post-quantum landscape. There remains an opportunity to improve data protection methodologies to withstand emerging quantum capabilities.

To address the vulnerabilities of classical cryptography, various quantum cryptographic and quantum data storage systems have been proposed. However, the physical implementation of quantum systems presents significant hardware challenges. Quantum states, such as superposition and entanglement, are inherently fragile and susceptible to environmental interference. Interactions with the surrounding environment induce decoherence, a process whereby a quantum system loses its quantum properties and collapses into a deterministic classical representation. Mitigating decoherence typically involves extreme environmental controls, including cryogenic cooling and electromagnetic shielding. Consequently, the deployment of persistent quantum memory for long-term data storage remains technically complex and resource-intensive. Existing approaches that attempt to maintain coherent quantum states over extended durations may not fully scale to meet enterprise or global storage demands.

Furthermore, fundamental principles of quantum mechanics constrain the manipulation of quantum information. The no-cloning theorem dictates that it is impossible to create an identical copy of an unknown quantum state. While this property offers theoretical security advantages for data transmission, it introduces substantial limitations for data redundancy, replication, and disaster recovery. Conventional distributed storage architectures rely on data replication across geographically diverse nodes to ensure fault tolerance. Integrating non-cloneable quantum memory into these highly available, redundant storage architectures presents inherent contradictions. There remains an opportunity to develop data protection models that leverage quantum properties without relying on the long-term persistence or replication of coherent quantum states.

Beyond pure quantum memory, hybrid quantum-classical architectures have been explored to bridge the gap between quantum processing advantages and classical storage reliability. In many existing hybrid implementations, quantum processors execute specific algorithms, while classical processors manage control flow and data persistence. However, when applied to data security, existing hybrid approaches often struggle with the transition boundary between quantum entropy and classical determinism. For instance, while quantum random number generators (QRNGs) or other non-deterministic entropy sources may generate highly unpredictable bitstreams, securely integrating this entropy into large-scale data segmentation and reconstruction workflows presents challenges. Existing systems may not fully optimize the generation of structured, deterministic metadata from these non-deterministic events to govern classical data reassembly securely.

The challenge of secure data reassembly extends to purely classical infrastructures as well. In environments lacking quantum processing capabilities, data security still relies on the quality of the underlying entropy utilized for cryptographic operations. Software-based pseudorandom number generators (PRNGs) yield deterministic outputs that, while statistically random, can theoretically be modeled or anticipated if the initial seed is compromised. Non-deterministic entropy sources, such as thermal noise, photonic emission, radioactive decay, and other non-deterministic entropy sources, may be used to provide randomness. Even when non-deterministic entropy is available, existing classical systems may not fully leverage this entropy to dictate the structural transformation, recursive segmentation, and non-deterministic reordering of datasets. An opportunity may exist to improve classical data storage models by integrating non-deterministic entropy into the physical organization and dispersion of the data itself, rather than merely utilizing it for encryption key generation.

Additionally, the reconstruction of distributed, fragmented data typically relies on centralized index tables or static metadata mappings. If an unauthorized entity acquires the index table, the fragmented data becomes vulnerable to reassembly or correlation attacks. Conversely, if the index table is lost or corrupted, the distributed data fragments are rendered permanently inaccessible. Existing methodologies may not fully address the vulnerabilities associated with centralized metadata architectures. There remains an opportunity to improve metadata governance by generating deterministic reconstruction keys that encode transformation lineage, entropy fingerprints, and structural dependencies, such that the metadata itself serves as a cryptographically verifiable prerequisite for data reassembly.

In summary, as computational architectures evolve toward quantum capabilities, conventional encryption and data storage paradigms face escalating vulnerabilities. Concurrently, the physical limitations of quantum memory and the no-cloning theorem restrict the practical deployment of fully quantum storage systems. Existing approaches may not fully address the need for a scalable, post-quantum architecture that captures the security advantages of quantum entropy while leveraging the stability, redundancy, and scalability of classical storage networks. There remains a significant opportunity to improve secure data transformation and reconstruction methodologies by intentionally utilizing irreversible measurement collapse or non-deterministic entropy vectors to drive data fractalization, while governing the subsequent classical reassembly through strictly deterministic, entropy-validated metadata structures.

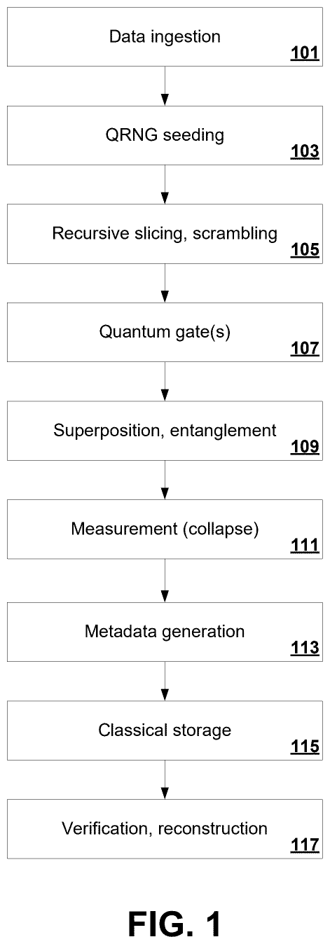

FIG. 1 is a flowchart illustrating an overview of a hybrid architecture for quantum computation and classical storage, according to at least one embodiment of the present disclosure. In some embodiments, the process may be executed by a computing system encompassing both classical processing hardware and quantum processing hardware linked via a communicative interface.

At block 101, data ingestion is performed. The input data may encompass any form of information representation, including data objects, unstructured bitstreams, linear files, structured documents, multimedia files, relational records, hierarchical trees, graph-structured datasets, database fields, or machine learning model weights, embeddings, and parameter maps. The system treats structural components, including nodes, edges, relational mappings, vectors, matrices, or field-level structures, as fragmentable elements subject to entropy-conditioned transformation.

Furthermore, data ingested at block 101 may include governance artifacts such as invariants, execution capabilities, or authorization logic. Invariants may be represented as executable logic, metadata structures, cryptographic expressions, capability objects, or any other suitable object. Invariants may represent a deterministically derived execution constraint generated from policies, signals, rules, or behavioral analysis that must evaluate to a valid state prior to permitting, modifying, redirecting, or denying an operation. Invariants may define conditions specifying permitted operations, prohibited operations, conditional constraints, temporal, spatial, causal, or state requirements, or other execution conditions that must evaluate to a valid state before an operation proceeds. A capability object may represent the authority necessary to execute a system-level action such as a system call, API invocation, tool execution, kernel transition, or autonomous action. A capability object may be conditionally validated, derived, or materialized at the execution boundary following successful evaluation of applicable invariants. These invariants are themselves subjected to entropy-conditioned fractalization and distribution across multiple storage domains, ensuring that the governing logic or validation conditions are not exposed in complete form to any single storage location. In such embodiments, the deterministic reassembly of the invariant structure is a cryptographic prerequisite for the execution of associated system operations or model inference.

At block 103, QRNG seeding is executed. A quantum random number generator (QRNG) or an alternative non-deterministic entropy source is leveraged to generate a non-deterministic entropy vector. This entropy vector introduces true unpredictability into the system, distinct from algorithmically generated pseudorandomness. In some embodiments, the entropy vector may feature a high-entropy bitstring (e.g., 256 bits, 512 bits, or larger) utilized to parameterize downstream transformations. Alternatively, if a QRNG is unavailable, other non-deterministic entropy sources such as atmospheric noise aggregators or chaotic oscillator circuits may be employed.

At block 105, recursive slicing and scrambling operations are applied. Driven by the non-deterministic entropy vector obtained at block 103, the input dataset is partitioned into a plurality of fragments. In some embodiments, the fragments may be assigned to exemplary structural classifications such as BiBits (binary-segmented fragments exhibiting statistical independence) or OrBits (fragments exhibiting orthogonally rotated characteristics). It is noted that these terms serve as exemplary structural classifications to aid in understanding the fractalization depth and do not limit the underlying data architecture. In some embodiments, optionally, an entropy-driven scrambling operation may subsequently reorders these fragments non-deterministically to disrupt positional predictability.

At block 107, one or more quantum gates are applied to the fragments, scrambled or non-scrambled. In some embodiments, this operation includes initializing a quantum processing environment and instantiating a quantum register with a plurality of qubits. Each qubit may be initialized to a specific basis state (e.g., a |0> or |1> basis state) based on the data encoding scheme. Subsequently, a sequence of quantum gate operations (e.g., Hadamard, CNOT, QFT, or phase shift gates) is applied to the qubits representing the input data. The specific gate sequence, including the depth and routing of the gates, may be dynamically determined based on the entropy vector generated at block 103. In at least one embodiment, the entropy-conditioned quantum gate sequence governs the resulting fractalization pattern of the input data.

At block 109, a state of superposition and entanglement is achieved. To preserve structural fidelity across heterogeneous datasets, the system applies cross-modal quantum gates to establish entanglement-driven references between disparate data types. For example, text-based metadata fragments may be explicitly entangled with specific image pixel clusters or video frame sequences, while audio segments are linked probabilistically via quantum phase states to numerical telemetry data. This multimodal entanglement ensures that the transformation preserves the semantic and logical integrity of the collective dataset; if an entanglement reference is lost or the measurement output of one modality fails to satisfy the entropy thresholds of a linked modality, the system denies the reconstruction of the entire multimodal set.

At block 111, a measurement operation is performed, resulting in a collapse of the quantum state. This measurement intentionally and irreversibly collapses the superposition and entanglement into a deterministic classical representation. The system does not attempt to preserve the coherent quantum state post-measurement. Rather, the irreversible collapse is utilized as a secure boundary event to extract unpredictable but subsequently verifiable classical outputs.

At block 113, metadata generation occurs. Based on the classical representation captured at block 111, the system deterministically generates metadata artifacts. Rather than generalized metadata, these artifacts may be encoded into specific machine-readable structures, such as hash-linked metadata graphs representing qubit index mappings and gate operation identifiers, transformation lineage trees detailing parent-child slice references, and quantum dependency vectors capturing entanglement pairing identifiers. This metadata deterministically encodes the transformation lineage, the entropy path, the gate execution history, and the structural dependencies of the collapsed data. In at least one embodiment, the metadata may be packaged into a reconstruction key that acts as a secure, mathematically deterministic map for the fractalized data.

At block 115, classical storage is utilized. The deterministic classical representations and the generated metadata are stored and distributed across classical infrastructure. In at least one embodiment, classical storage may include at least one of geographically redundant nodes, centralized networks, decentralized ledger networks (e.g., BlockDAG), isolated on-premise enclaves, or any other network structure. In at least one embodiment, to ensure structural resilience and security, the system may enforce a quorum-based retrieval mechanism, where reconstruction is only permitted when a minimum quorum of nodes returns the validated fragments and their associated metadata hashes. The use of classical storage bypasses the need for fragile, persistent quantum memory while retaining post-quantum security characteristics.

At block 117, verification and reconstruction operations are conducted. When a reconstruction request is initiated, the system retrieves the stored components and validates the stored metadata and the entropy fingerprints. For verification, the system may simulate the quantum transformation based on the stored metadata to regenerate structural hashes and compare them against the originally stored hashes. If the regenerated hashes match and the quorum of segments is available, the validation is successful, and the classical infrastructure reverses the slicing and/or scrambling operations based on the lineage map (e.g., part of a reconstruction key) to reconstruct the original input dataset. If the metadata is incomplete, fails hash validation, or lacks the required quorum, the reconstruction operation is aborted, thereby providing a tamper-evident security mechanism.

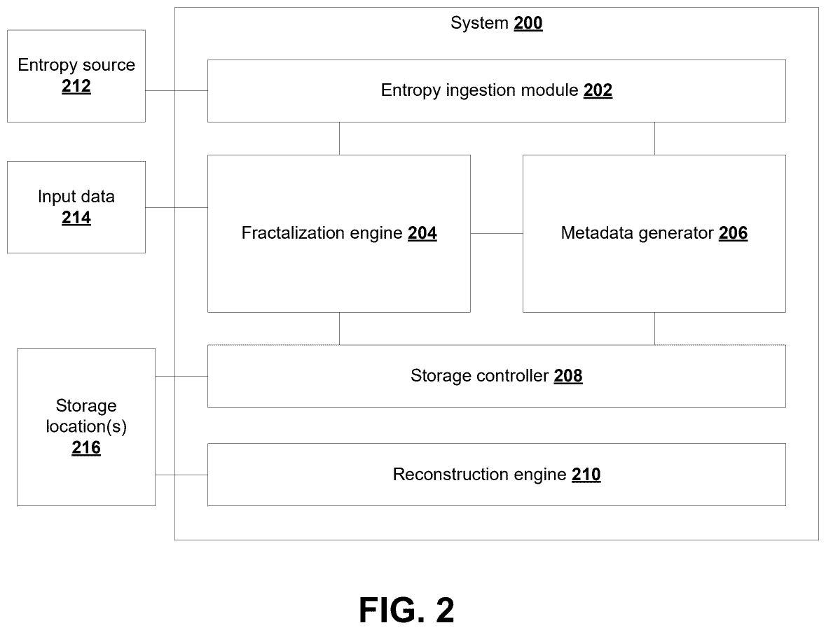

FIG. 2 is a block diagram illustrating a system 200 for entropy-conditioned data fractalization and reconstruction, according to at least one embodiment of the present disclosure. In at least one embodiment, the system 200 is implemented using classical computing infrastructure, hybrid quantum-classical infrastructure, or a combination thereof. In at least one embodiment, the system 200, along with its internal components such as the entropy ingestion module 202, the fractalization engine 204, the metadata generator 206, the storage controller 208, and the reconstruction engine 210, may be instantiated as physical hardware computing structures. For example, these components may include one or more hardware processors coupled to non-transitory computer-readable memory, Application Specific Integrated Circuits (ASICs), Field Programmable Gate Arrays (FPGAs), distributed cloud microservices operating across a zero-trust mesh architecture, standalone entropy-driven data sharding appliances, or endpoint-integrated libraries operating at the file system or application layer. The system 200 may be deployed within data centers subject to air-gapped or sovereign storage requirements.

The system 200 receives entropy from anon-deterministic entropy source 212. The non-deterministic entropy source 212 may include a quantum random number generator (QRNG), a FIPS-validated classical entropy source, or another hardware-based non-deterministic entropy appliance that generates unpredictability from physical phenomena, such as thermal noise, photonic emission, or radioactive decay. Simulated entropy sources or algorithmic pseudorandom number generators (e.g. PRNGs, CSPRNGs, etc.), even if statistically random, may not satisfy the requirements for QRNG-seeded processes in high-security applications, and thus the non-deterministic entropy source 212 serves to introduce irreducible physical randomness into the system 200. In certain implementations, this may involve secure co-processing environments in which entropy is streamed over Transport Layer Security (TLS) channels from remote QRNG services without requiring local quantum computation.

Concurrently, the system 200 receives input data 214. The input data 214 may encompass data objects (e.g., structured data, unstructured data, or multimodal datasets), invariants, execution capabilities (e.g., capability objects), or authorization logic. Once the input data 214 and the entropy from the non-deterministic entropy source 212 are received, the system 200 initiates the transformation workflow.

The entropy ingestion module 202 serves as the initial verification gateway for the physical randomness. Rather than blindly passing entropy to downstream components, the entropy ingestion module 202 evaluates the freshness and quality of the ingested entropy prior to any data transformation. In some embodiments, this evaluation involves applying entropy source validation routines, such as min-entropy threshold tests or randomness quality classifiers, to the incoming entropy vector. Upon successful validation, the entropy ingestion module 202 produces entropy fingerprint hashes, which are retained to guarantee lineage consistency during later reconstruction phases. To further enhance security, the entropy ingestion module 202 may enforce stateless processing, ensuring no entropy is reused or persisted, or it may utilize ephemeral entropy pools governed by destruction-on-read policies.

The fractalization engine 204 (also referred to herein as a fractalization engine) is communicatively linked to the entropy ingestion module 202 and receives the input data 214. The fractalization engine 204 executes recursive segmentation on the input data streams. Instead of employing static or user-defined segmentation rules, the fractalization engine 204 derives transformation parameters directly from the validated entropy vector. These parameters dynamically dictate the segment length, the slice offset, the recursion depth, and the interleaving patterns applied to the input data 214. As a result, the input data 214 is partitioned into a plurality of entropy-weighted fragments, which may be organized into exemplary structural categories such as BiBits, OrBits, or QBits depending on the operational mode.

Operating in parallel or sequentially with the fractalization engine 204, the metadata generator 206 receives the fragmentation pattern from the fractalization engine 204 and the entropy fingerprint from the entropy ingestion module 202. The metadata generator 206 produces a reconstruction key, which is a unique, encoded, encrypted structure that enables, conditions, or governs the reassembly of fractalized data which encode transformation lineage, entropy fingerprints, segment positioning, and other detailed, per-fragment deterministic metadata. This may include any identifiers, hashes, transformation coordinates, gate lineage, or any combination thereof. In certain implementations, this metadata explicitly encodes the fragment index position, the designated entropy class, a segment dependency vector, the complete transformation pathway, and an entropy seed signature. Furthermore, the metadata generator 206 may generate a seed-class hash identifying the specific entropy source and time window, a fragmentation signature representing a cryptographic hash of the recursive slicing pattern applied, and a transformation digest detailing segment reordering keys along with any rotation, inversion, or XOR operations governed by the entropy. This deterministic metadata guarantees reproducibility, auditability, and compatibility with distributed validation mechanisms without introducing post-transformation randomness that would undermine the integrity of the security model. In at least one embodiment, a reconstruction integrity check is performed to verify that the reconstruction key is valid, not corrupt, and capable of reconstructing the data. In at least one embodiment, the reconstruction integrity check is run before an object is released and/or memory is zeroized. In at least one embodiment, if the reconstruction integrity check fails, data is encrypted without a usable key such that a user will not be able to access the data.

In at least one embodiment, the system executes strict integrity checks at both the creation of the fragments and during the reconstruction phase to prevent unintended data loss. Because the deterministic reconstruction key utilizes information-theoretic encryption, the security model is absolute; there is no computational workaround, brute-force mechanism, or fallback key to recover the input dataset if a fragment is corrupted, tampered with, or improperly generated. To account for this, the system generates a cryptographic hash upon the creation of the entropy-weighted fragments and performs an immediate, initial integrity check prior to storage. If this initial creation-phase check fails, the system aborts the operation to prevent the storage of permanently unrecoverable data. Similarly, a subsequent integrity check is performed during the reconstruction phase by recomputing and verifying the cryptographic hash. If the reconstruction-phase check fails, the data remains permanently inaccessible, ensuring that any structural deviation results in secure, irreversible data loss rather than unauthorized access or partial data leakage.

Once the data is transformed and the metadata is generated, the storage controller 208 manages the distribution of the outputs. The storage controller 208 dynamically determines storage distribution paths using the non-deterministic entropy input, thereby avoiding fixed or predictable endpoint assignments. By utilizing entropy-derived sharding keys, the storage controller 208 routes the fragments and the deterministic metadata to one or more storage location(s) 216. In at least one embodiment, storage location(s) 216 may include one or more of distributed nodes within a decentralized hash table (DHT), a decentralized ledger technology, a blockchain-like storage structure, a globally distributed zero-trust architecture, or any other storage method/structure.

The reconstruction engine 210 governs the reassembly of the original data. When a reconstruction request is initiated, the reconstruction engine 210 calls the reconstruction key, re-ingests the original entropy vector (or a corresponding cryptographic hash) and cross-validates it against the deterministic metadata embedded with the fragments retrieved from the storage location(s) 216. The reconstruction engine 210 computes the expected structural outcomes based on the retrieved metadata and the entropy fingerprint utilizing the reconstruction key. If any mismatch is detected in the entropy origin, the fragment sequence, number of fragments, or the transformation path, the reconstruction engine 210 aborts the reassembly process immediately. Such mismatch events may be securely logged for subsequent audit and forensic review. This rigorous validation mechanism guarantees zero-trust reconstruction and thoroughly impedes attempts to spoof or replay fragmented datasets.

In at least one embodiment, the fractalization engine 204 may perform fragmentation without reliance on an external metadata table or lineage graph. Instead, the fractalization engine 204 may embed self-descriptive information directly within the fragments, such as positional indicators, chaining identifiers, sequence checksums, or entropy tags. This embedded structure enables the reconstruction engine 210 to perform local or pairwise reconstruction autonomously. Furthermore, the fractalization engine 204 may utilize algebraic combination techniques to govern fragment generation. For instance, the fragmentation process may incorporate erasure coding, homomorphic encryption, or cryptographic secret sharing schemes. In such implementations, no single fragment reveals information independently, and the reconstruction engine 210 requires only a specific mathematical combination or threshold of fragments to enable reassembly, circumventing the need for external positional metadata entirely.

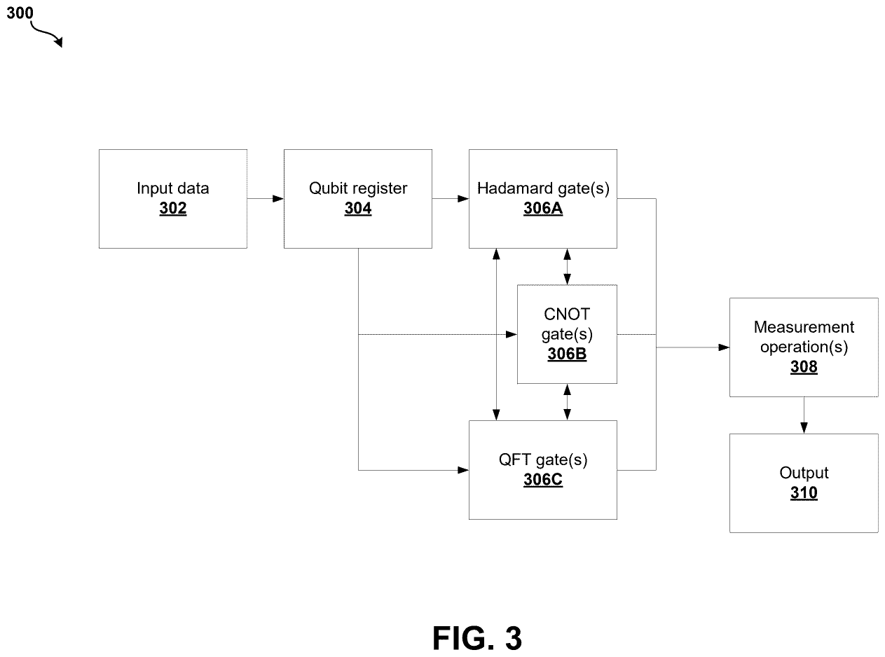

FIG. 3 is a diagram illustrating a quantum gate flow 300 including Hadamard, CNOT, and QFT gates, according to at least one embodiment of the present disclosure. The quantum gate flow 300 may operate within the hybrid quantum-classical architecture to introduce high-entropy transformations and structural dependencies into an input dataset.

Input data 302 is received and mapped into a quantum processing environment. Prior to or during this mapping, semantic classifiers and structural heuristics may be utilized to assign the data into nested subsets and categories. In at least one embodiment, artificial intelligence-assisted tagging modules may guide this initial categorization. The quantum processing environment incorporates a qubit register 304 encompassing a plurality of qubits. Each qubit within the qubit register 304 may be initialized to a specific basis state based on the selected data encoding scheme.

Following initialization, the qubits within the qubit register 304 are subjected to a sequence of quantum gate operations. As illustrated, these operations may include one or more Hadamard gate(s) 306A or similar (e.g., superposition gates, basis-transformation gates, unitary mixing gates, rotation gates, or probabilistic state-transformation gates). The Hadamard gate(s) 306A introduce superposition to the targeted qubits, placing them into a probabilistic state, such as linear combinations of basis states. This characteristic permits fractal patterns to be explored in parallel, supporting increased entropy and structure multiplicity during the quantum transformation process. As multiple Hadamard gate(s) 306A are applied recursively, the number of possible computational branches may increase exponentially, resulting in deeply nested probabilistic transformations.

Additionally, the sequence of quantum gate operations may include one or more Controlled-NOT (CNOT) gate(s) 306B or similar (e.g., controlled gates, entanglement gates, conditional logic gates, multi-qubit correlation gates, or controlled unitary operations). The CNOT gate(s) 306B entangle qubits based on conditional logic between control and target qubits, establishing strict structural dependencies between different branches of the fractalized data. Through this entanglement, the destruction or loss of any entangled reference renders complete data reconstruction impossible, thereby introducing an inherent, structural anti-tampering enforcement mechanism.

Furthermore, the gate sequence may include one or more Quantum Fourier Transform (QFT) gate(s) 306C, or similar (e.g., phase-transformation gates, amplitude-transformation gates, quantum scrambling gates, spectral redistribution gates, quantum mixing operations), or any other composite gate structures. The QFT gate(s) 306C are utilized to recursively modulate the quantum state across the amplitude spectrum. In certain implementations, the QFT gate(s) 306C enhance data obfuscation by diffusing phase information and redistributing it non-linearly across varying qubit combinations. To further destroy linear position references and positional predictability, the sequence may incorporate quantum scrambling logic comprising phase shifts, entanglement-swaps, and dynamic reordering operations. This operation amplifies recursive structures and encodes non-deterministic characteristics deeply into the final fractalized output.

The sequence, ordering, and recursive depth of the Hadamard gate(s) 306A, the CNOT gate(s) 306B, and the QFT gate(s) 306C are dynamically determined by a non-deterministic entropy source such that the resulting fractalization of the data is entropy-conditioned. In some embodiments, artificial intelligence-driven quantum entropy models may drive a continuous evolution of component segmentation and reordering. This adaptive obfuscation ensures that repeated fractalization of identical datasets produces structurally distinct outputs, thereby enforcing forward secrecy and no-cloning resilience. The continuous interaction between these gates yields deeply nested, probabilistic transformations that are cryptographically resilient to reverse engineering.

Upon completion of the quantum gate operations, a measurement operation(s) 308 is executed on the qubit register 304. The measurement operation(s) 308 irreversibly collapses the superpositioned and entangled quantum states into a deterministic classical form, producing an output 310. The output 310 features a classical bitstring representing the fractalized data, alongside metadata artifacts encoding the entanglement topologies, the transformation parameters, and the structural integrity hashes. The resulting fragmented data may be classified as QBits, which represent segments whose structural or informational characteristics are directly influenced by the quantum gates, quantum entanglement, or quantum superposition. The system preserves the output 310 in classical storage without attempting to sustain, preserve, or reconstruct the pre-measurement coherent quantum states.

In certain alternative implementations, such as quantum-only embodiments, the data may be encoded into a plurality of quantum states or entangled qubits and distributed across physical or logical nodes without requiring classical metadata to facilitate reconstruction. In such configurations, joint quantum operations, including entangled measurement, quantum interference, or inference via correlated states, may be utilized to recover the original data when all necessary qubits are available, thereby providing an entirely quantum-native reconstruction pathway.

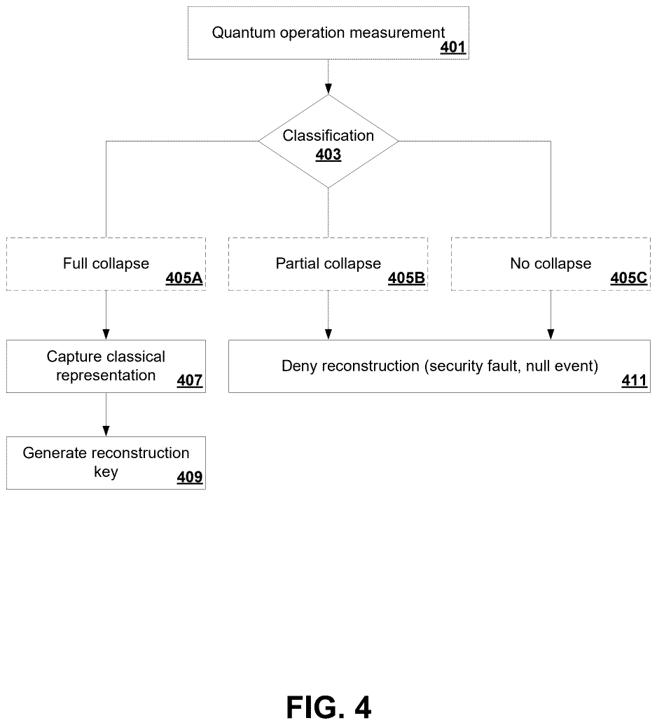

FIG. 4 is a flowchart illustrating the classification logic for quantum measurement collapse, according to at least one embodiment of the present disclosure. This logic ensures that the measurement of quantum states serves as a secure, deterministic boundary event, converting quantum uncertainty into reproducible, verifiable classical structures.

At block 401, a quantum operation measurement is performed. This measurement captures the state of the quantum processing environment following the application of quantum gate sequences. The measurement forces an irreversible transition from a coherent quantum state to a classical outcome.

At block 403, a classification operation is executed. The system evaluates the observed measurement collapse and categorizes the result into one of three distinct categories to ensure data integrity and security. Because quantum hardware may be subject to noise, decoherence, or incomplete gate execution, this classification step filters out unviable outputs.

Block 405A represents a full collapse. A full collapse occurs when a quantum state is measured cleanly, producing a classical bitstring that satisfies predefined entropy thresholds, entanglement collapse signatures, and gate lineage integrity checks. This state represents the standard operational mode of the hybrid system.

If a full collapse 405A is identified, the process proceeds to block 407, where the classical representation is captured. Following this, at block 409, a reconstruction key is generated. The reconstruction key encodes the structured metadata derived from the full collapse, allowing downstream reconstruction and validation based on the metadata lineage. In at least one embodiment, the deterministic metadata may optionally include noise signatures and collapse identifiers to securely characterize the specific measurement event and account for acceptable hardware measurement variations. In classical-only implementations, no quantum collapse is measured or classified. Instead, entropy vector validation is treated as the structural analog to a full collapse. A full collapse equivalent may be achieved when a re-ingested entropy vector deterministically reproduces the original segmentation logic and passes all metadata validation checkpoints. Additionally, in implementations configured to mimic quantum-style reconstruction without an external map, the captured representation may include embedded structures, such as header fields, entropy descriptors, or fragment identifiers, enabling reassembly via scanning for overlapping byte patterns or neighbor-referencing tags.

Block 405B represents a partial collapse. A partial collapse arises when the quantum state undergoes an incomplete or noisy measurement, resulting in partial decoherence or data leakage. This condition may occur due to environmental noise, timing anomalies, or gate misfires. Such scenarios may yield a malformed or entropy-deficient output, incomplete entanglement signatures, or invalid metadata hashes, causing the output to fail validation through entropy threshold gating, hash verification, or reconstruction key mismatches.

Block 405C represents no collapse. No collapse occurs when the quantum operation fails to produce any measurable output. This event may happen if no measurement is triggered, the quantum state decoheres silently prior to observation, or the capture mechanism fails to register an event.

If either a partial collapse 405B or no collapse 405C is identified, the process proceeds to block 411, where reconstruction is explicitly denied. A partial collapse is treated as a security fault, and any attempts to utilize its output will fail subsequent validation checks. These fault events may be logged for audit and forensic review, but they are strictly prohibited from triggering successful reassembly. A no collapse event is treated as a null event, resulting in no classical record and no metadata generation. In classical-only implementations, if the non-deterministic entropy is weak, reused, or inconsistent, the metadata will fail to align with the segment structure and hash chains will mismatch. This failure state explicitly mirrors the partial collapse or no collapse states, resulting in the reassembly being blocked.

By automatically rejecting partial or non-collapsed states, the system prevents replay attacks, forgery, and unauthorized reconstructions, thereby utilizing the measurement collapse itself as an active security perimeter rather than a point of failure. The irreversible nature of the collapse is thus leveraged as a security guarantee; because the collapse cannot be reversed, an adversary is prevented from faking, rewinding, or replicating the original quantum state, thereby providing robust anti-cloning and tamper-resistance properties.

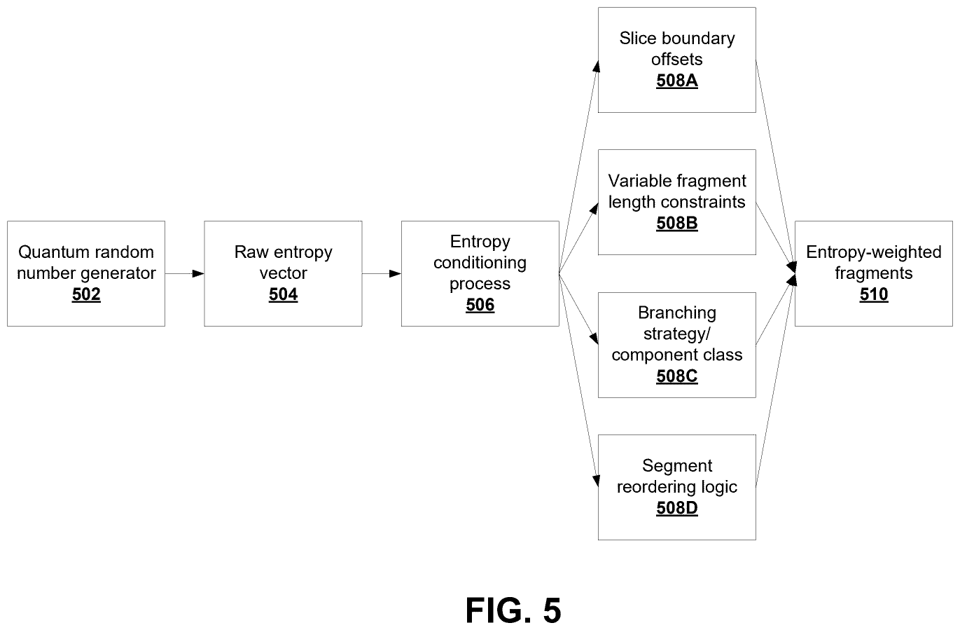

FIG. 5 is a block diagram illustrating an entropy injection mapping, according to at least one embodiment of the present disclosure. This mapping demonstrates the transformation of input data into entropy-weighted fragments utilizing classical-only infrastructure driven by physical non-determinism, though it may optionally be applied within hybrid quantum-classical architectures.

A quantum random number generator 502, or an equivalent non-deterministic entropy source, is utilized to produce a raw entropy vector 504. The quantum random number generator 502 provides physically non-reproducible unpredictability, leveraging phenomena such as thermal noise, photonic emission, radioactive decay, or physically unclonable processes. By utilizing true non-deterministic entropy rather than algorithmic pseudorandomness, the system ensures that the downstream fragmentation sequences are cryptographically resilient against prediction or modeling attacks. In some embodiments, the generated entropy is evaluated for freshness and quality using min-entropy threshold tests prior to transmission. Furthermore, the raw entropy vector 504 may be uniquely bound to a specific user, operating environment, or session. This per-session or per-user transformation logic ensures that identical input datasets processed under different sessions will generate entirely distinct fragmentation patterns and structural metadata.

The raw entropy vector 504 is received and subjected to an entropy conditioning process 506. The entropy conditioning process 506 translates the raw, unstructured randomness into specific, non-deterministic parameters utilized to govern the recursive segmentation and transformation of an input dataset. Rather than applying fixed-size blocks or user-defined segmentation rules, the entropy conditioning process 506 derives multiple dynamic transformation variables directly from the raw entropy vector 504. These variables include, but are not limited to:
(i) segmentation boundaries or partition points, wherein entropy vectors are mapped to offset values that define where the dataset is sliced, split, divided, or partitioned;
(ii) variable-sized segments or non-uniform partitions, wherein entropy-conditioned constraints define fragment lengths such that resulting segments are unequal, non-repeating, and non-predictable in size;
(iii) a dynamically determined plurality of fragments, wherein the number of segments produced during fractalization is derived from entropy-conditioned recursion depth, branching factors, or slice count targets;
(iv) reconstruction sequence or permutation mapping, wherein entropy-derived ordering parameters determine the logical or positional sequence in which fragments are arranged, stored, or later reconstructed;
(v) storage location mapping or distribution metadata, wherein entropy-derived addressing parameters determine fragment placement across storage systems, including spatial coordinates, node assignments, access paths, or transformation-derived positioning; and
(vi) integrity verification data or hash material, wherein entropy is used to seed cryptographic hash functions, entropy fingerprints, or transformation digests that are bound to each fragment and its associated metadata to enable validation during reconstruction.

The fractalization operations directed by the entropy conditioning process 506 may be applied to plaintext data prior to cryptographic encryption or applied to ciphertext data following an encryption operation, allowing flexible integration into existing data security pipelines.

While the primary operations leverage non-deterministic entropy, alternative embodiments explicitly incorporate non-entropic fractalization methods to provide fallback configurations or specific structural formatting. These alternative methods may include deterministic segmentation logic (e.g., fixed-length partitioning or mathematical set decomposition), algorithmic structural divisions (e.g., binary-tree segmentation or fixed-interval slicing), or artificial intelligence-driven fragment generation (e.g., deep-learning-guided semantic segmentation). In such configurations, the metadata encoding the lineage and structural dependencies is strictly preserved to ensure deterministic reconstruction.

The dynamic variables derived by the entropy conditioning process 506 dictate multiple operational parameters for the fractalization engine. First, the entropy governs slice boundary offsets 508A, which determine the exact logical or physical coordinates where the input dataset is partitioned. Second, variable fragment length constraints 508B are dynamically established by the entropy conditioning process 506. This ensures that the resulting data fragments are unequal, irregular, or varying in size, which amplifies obfuscation compared to traditional uniform data chunking.

Third, the entropy dictates a branching strategy/component class 508C. As the data is recursively partitioned, the entropy vector dynamically determines the hierarchical branching path and assigns the resulting substructures into specific component classes. In some embodiments, these classes include BiBits representing binary-segmented fragments, OrBits representing orthogonally rotated, statistically independent structures, QBits representing quantum-conditioned entropy units derived from superposition states or entanglement-informed collapse paths, as well as nested, overlapping, and categorical components. The utilization of OrBits supports orthogonal fractalization, which partitions the data into independent, non-overlapping subsets that can be processed concurrently. This structure provides scalable entropy injection and parallel fractalization streams, optimizing latency for complex workloads such as distributed artificial intelligence models, machine learning environments, or large language models (LLMs). Furthermore, in multimodal systems, the branching strategy/component class 508C may generate modality-linked metadata structures that describe intra-fragment and inter-fragment relationships across text, audio, image, or structured numerical datasets.

Fourth, segment reordering logic 508D is generated. The segment reordering logic 508D is applied to scramble the generated segments non-deterministically. This scrambling destroys positional predictability and eliminates any linear correlation between the original input data sequence and the final fragmented output, thereby enhancing anti-correlation security against advanced inference attacks. In advanced implementations, artificial intelligence models may dynamically guide the segment reordering logic 508D to enforce adaptive obfuscation, ensuring that transformation paths continuously evolve.

Fifth, the entropy conditioning process derives storage location mapping and distribution metadata. Rather than utilizing static or user-defined endpoint assignments, entropy-derived addressing parameters dynamically determine the placement of each fragment across the available storage systems. These entropy-derived placement values may govern specific node assignments, geographic region assignments, logical partitions, access paths, addressing schemes, or transformation-derived positioning for both the fragments and their associated metadata. By utilizing non-deterministic entropy to dictate the storage distribution, the system ensures that fragment locations remain entirely unpredictable and avoid deterministic storage paths.

Sixth, the system derives integrity verification data and hash material directly from the entropy input and fragment state. The non-deterministic entropy is used to seed cryptographic hash functions, producing unique entropy fingerprints, structural hashes, lineage digests, and transformation signatures. This entropy-seeded hash material is cryptographically bound to each respective fragment, encompassing its associated position, ordering, parent-child relationship, and placement metadata. During the reconstruction phase, this integrity verification data enables strict, deterministic validation. Reconstruction is permitted only if the retrieved fragments and metadata perfectly satisfy the encoded transformation parameters and their associated entropy-derived validation criteria.

The application of these dynamic, entropy-driven parameters yields a plurality of entropy-weighted fragments 510. Each of the entropy-weighted fragments 510 represents a distinct piece of the original dataset that has been sized, categorized, and positioned entirely based on the raw entropy vector 504. Furthermore, each fragment is tagged with deterministic metadata encoding its transformation path, entropy seed, structural class, and segment fingerprint. In at least one embodiment, these may be considered BI-IDs and/or OR-IDs. The entropy-weighted fragments 510 are subsequently distributed across one or more classical storage locations. These distributed metadata structures remain fully compatible with oracle-based quorum verification, distributed ledger anchoring, zero-trust reassembly pipelines, and/or any other distributed or centralized verification method. The ultimate reconstruction of the input data relies exclusively on the deterministic reproduction of the entropy-conditioned transformation sequence through strict validation of the metadata and the originating raw entropy vector 504 using a reconstruction key(s).

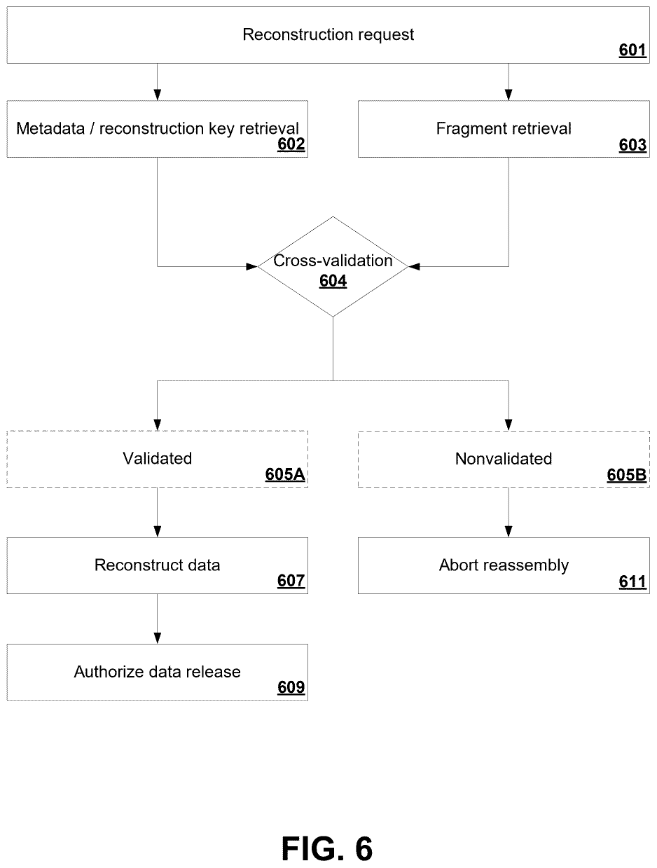

FIG. 6 is a flowchart illustrating a classical verification and reassembly workflow using stored metadata, according to at least one embodiment of the present disclosure. This workflow governs the retrieval, validation, and reconstruction of fractalized data components across classical infrastructures, operating independently of persistent quantum memory.

At block 601, a reconstruction request is received. This reconstruction request may originate from a user, a system application, an external agent, or a distributed computing oracle. The request may contain encryption keys, original session-bound reconstruction keys, and an original non-deterministic entropy vector or a corresponding cryptographic hash required to authenticate the reassembly process.

At block 602, metadata and reconstruction key retrieval is performed, and at block 603, fragment retrieval is executed. The system fetches the entropy-weighted fragments and the associated deterministic metadata from one or more classical storage locations. In at least one embodiment, the retrieval process may require a minimum quorum of geographically redundant storage nodes to return validated fragments and metadata before proceeding, thereby enforcing distributed trust. In at least one embodiment, all fragments must be retrieved and/or verified for reconstruction to be successful. In at least one embodiment, the fragment retrieval operation at block 603 may operate independently of the external metadata retrieval at block 602. For example, the fragments may feature embedded self-descriptive information, such as positional indicators, chaining identifiers, sequence checksums, or entropy tags, enabling local or pairwise reconstruction without referencing a central index. In other implementations, fragments may be algebraically linked through erasure coding, homomorphic encryption, or cryptographic secret sharing schemes, wherein no fragment reveals information independently and only a threshold mathematical combination enables reconstruction.

At block 604, a cross-validation operation is executed. The retrieved metadata, the fragments, and the reconstruction keys are evaluated. The integrity of the reconstructed data is validated by recomputing cryptographic hashes and verifying structural fingerprints against the retrieved metadata artifacts and/or the reconstruction key. The cross-validation operation may include checking entropy consistency, gate execution lineage, structural fingerprint hashes, and structural fidelity testing. In some embodiments, the cross-validation operation is facilitated by an alignment engine that ingests the encoded identifiers, performs deterministic graph traversal based on dependency hierarchies, and validates the full restoration path prior to permitting bit-level reassembly.

The validation process may further incorporate collision resistance mechanisms utilizing structured hash spaces, entropy-sensitive domains, or lattice-informed mappings to ensure that only entropy-consistent or context-bound identifiers successfully pass verification. Validation is designed to fail automatically if any fractal component is missing or scrambled out of sequence, if entanglement relationships do not align with the stored metadata, or if the structural entropy parameters are incorrect or incomplete. For hybrid quantum-classical implementations, the validation may involve simulating a quantum transformation based on the stored metadata to regenerate structural hashes for comparison against the originally stored hashes. In classical-only implementations, the validation involves, via the reconstruction key, confirming that the re-ingested entropy vector deterministically reproduces the original segmentation logic and matches embedded seed-class hashes, fragmentation signatures, and transformation digests. Furthermore, reconstruction requests originating from external agents or distributed oracles may be conditionally processed only after rigorous metadata integrity and transformation lineage verification, which may be facilitated through zero-knowledge proofs or distributed ledger anchoring to ensure trustless verification without exposing the underlying data.

Block 605A represents a validated state, whereas block 605B represents a nonvalidated state.

If the cross-validation evaluates to the validated state 605A, the process advances to block 607 for reassembly. In at least one embodiment, reassembly is governed by algebraic combination rather than positional metadata. Fragments are transformed into a plurality of cryptographically linked components using an algebraic relation, such as erasure coding, homomorphic encryption, or Shamir's Secret Sharing. In this configuration, no single fragment reveals information about the original data, and the reconstruction engine requires only a threshold mathematical combination of fragments to recover the input, rendering the system independent of specific fragment ordering or centralized lineage graphs.

In at least one embodiment, the system utilizes a self-descriptive fragmentation process to enable reassembly without reliance on an external metadata table or index. Each fragment is encoded with an internal structure comprising positional indicators, neighbor-referencing tags, sequence checksums, or entropy markers. The reconstruction engine identifies the reassembly path by scanning and matching these internal descriptors or interpreting overlapping byte patterns. These descriptors are themselves obfuscated such that only an authorized system, possessing the original session-bound entropy seed, can interpret the structural relationships.

In at least one embodiment, the system supports a degraded fidelity reconstruction mode. A tunable entropy threshold is defined whereby the system permits partial reassembly if the available metadata or entropy fingerprints achieve a minimum statistical match. The resulting output is intentionally degraded or lossy based on the degree of entropy mismatch. Any reconstruction attempt falling below the defined threshold results in zero or intentionally corrupted output to prevent data leakage.

Following reconstruction, an authorization for data release is executed at block 609. The fully reassembled and verified dataset is provided to the requesting entity, ensuring a zero-trust reassembly pipeline.

Conversely, if the cross-validation evaluates to the non-validated state 605B due to mismatched hashes, missing fragments, incorrect entropy signatures, or tampered metadata, the process diverges to block 611, where reassembly is aborted. The system enforces an integrity-based reconstruction model where partial or tampered reassembly attempts yield null or corrupted output unless explicitly governed by degraded fidelity thresholds. Reassembly is blocked to prevent replay attacks, forgery, and unauthorized data access. The aborted reconstruction events may be securely logged for audit and forensic review, guaranteeing that tampering or incompleteness renders the original data unreconstructable.

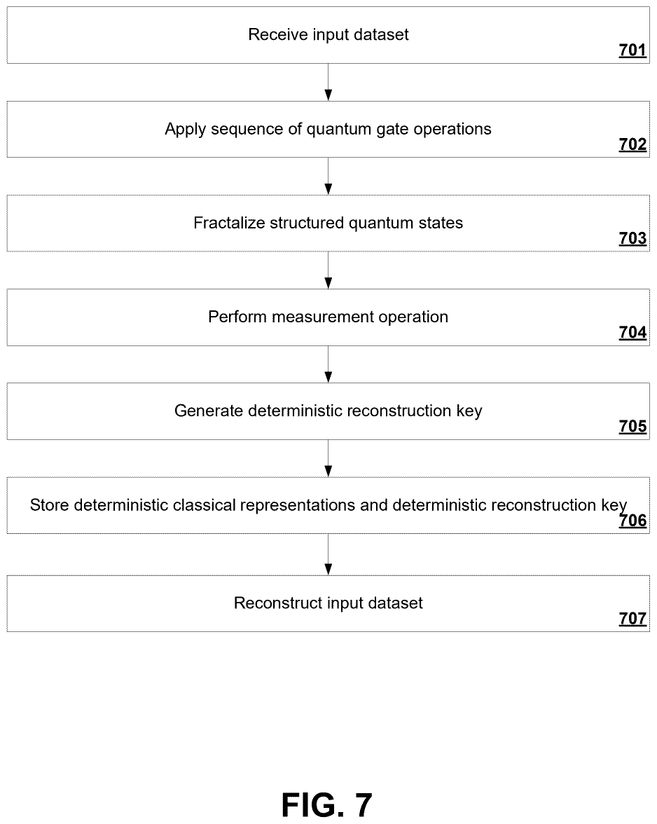

FIG. 7 is a flowchart illustrating a method for secure data transformation and reconstruction, according to at least one embodiment of the present disclosure. This method outlines a hybrid quantum-classical operational pipeline designed to secure data without relying on persistent quantum memory.

At block 701, an input dataset is received. The input dataset may originate from a classical data source and may encompass various formats, including unstructured bitstreams, structured documents, multimedia files, machine learning model parameters, or graph-structured datasets. In some embodiments, the process includes initializing a quantum processing environment and instantiating a quantum register with a plurality of qubits. Each qubit may be initialized to a specific basis state (e.g., a |0> or |1> basis state) based on a selected data encoding scheme, while a classical control unit synchronizes the quantum execution.

At block 702, a sequence of quantum gate operations is applied. This sequence of quantum gate operations is based at least in part on a non-deterministic entropy source. In some embodiments, the non-deterministic entropy source includes a quantum random number generator or other non-deterministic entropy hardware capable of producing irreducible randomness. The application of the sequence of quantum gate operations, which may include Hadamard, CNOT, Quantum Fourier Transform, phase shift, or SWAP gates, encodes entropy, superposition, and entanglement into structured quantum states representing the input dataset. In certain implementations, the gate sequence depth and qubit targeting are dynamically adjusted by the entropy source to ensure transformation paths are non-replicable. These quantum operations may utilize unitary quantum transformations, parametric quantum circuits, or variational circuits to create exponentially more transformation pathways compared to classical methods.

At block 703, the structured quantum states are fractalized. Specifically, the structured quantum states are recursively fractalized into entropy-weighted fragments. This fractalization may be applied to plaintext data prior to encryption, to ciphertext data following an encryption operation, or at intermediate stages of a cryptographic workflow. During this process, semantic classifiers and artificial intelligence-assisted tagging modules may be utilized to assign data into nested subsets and categories. Furthermore, for multimodal data (e.g., text, audio, video), entanglement links may be explicitly embedded across modalities, such as embedding entanglement-driven references linking text metadata fragments directly to image pixels or video frames. As the data is partitioned, the process produces varying fragment types, such as variable-length substructures, which may include BiBits, OrBits, or QBits.

At block 704, a measurement operation is performed. The measurement operation intentionally and irreversibly collapses the structured quantum states into deterministic classical representations. This irreversible collapse is utilized as a secure, one-way boundary event that ensures no adversary can fake, rewind, or replicate the original quantum state. To ensure system security and data integrity, the irreversible collapsing may be classified into distinct categories, such as a full collapse, a partial collapse, or no collapse. Measurement error or hardware noise may be accounted for by incorporating noise signatures and collapse identifiers into the resulting metadata.

At block 705, a deterministic reconstruction key is generated. This key may be referred to as a Reconstruction Vector Key (RVK) or a Quantum Identifier (Q-ID). The deterministic reconstruction key encodes structured metadata, which explicitly describes the transformation lineage, the entropy fingerprints, and the structural relationships of the deterministic classical representations. This metadata is session-bound, reproducible within the originating context, but cryptographically non-invertible across independent sessions. The metadata may be formatted as hash-linked metadata graphs, transformation lineage trees, quantum dependency vectors, or storage mapping schemas. The deterministic reconstruction key is strictly classical such that it does not preserve quantum coherence or allow for the regeneration of the original pre-measurement quantum state.

At block 706, the deterministic classical representations and the deterministic reconstruction key are stored. The storage utilizes a classical storage system, which may be deployed in cloud-native, enterprise, or air-gapped environments. In some implementations, storing the deterministic classical representations involves distributing the deterministic classical representations across geographically redundant classical storage nodes to ensure fault tolerance and eliminate single points of failure.

At block 707, the input dataset is reconstructed. The reconstruction is executed utilizing classical infrastructure by validating the entropy fingerprints and the structural relationships of the structured metadata encoded in the deterministic reconstruction key. Conceptually, reconstruction involves arranging data fragments by shape, characteristic, or classification using the reconstruction map provided by the metadata. In some embodiments, the system performs verification by simulating the quantum transformation based on the stored metadata to regenerate structural hashes for comparison against the originally stored artifacts. The reassembly process may further utilize an alignment engine to perform deterministic graph traversal based on dependency hierarchies to validate the full restoration path prior to bit-level reassembly. Verification may optionally be performed using zero-knowledge proofs or other cryptographic oracles to confirm reconstruction eligibility without exposing the underlying data. Reassembly may be achieved without reliance on a centralized index or external mapping table.

The reconstruction of the input dataset is permitted only if the irreversible collapsing was previously classified as a full collapse, and reconstruction is explicitly denied if classified as a partial collapse or no collapse. Any attempt at partial reconstruction or brute-force matching of fragments without quantum-derived lineage approval is rendered cryptographically infeasible. Furthermore, if distributed storage is utilized, reconstructing the input dataset may require a quorum-based validation from the geographically redundant classical storage nodes. The entire reconstruction process operates securely without utilizing quantum memory or persistent quantum entanglement.

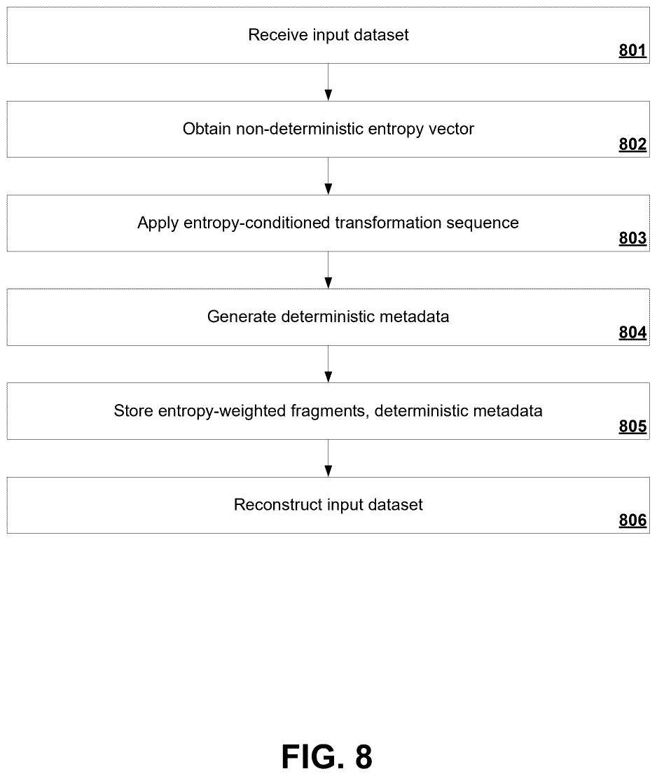

FIG. 8 is a flowchart illustrating a method for secure data transformation and reconstruction using classical-only infrastructure, according to at least one embodiment of the present disclosure. This embodiment provides an entropy-governed transformation framework that excludes quantum gate operations while maintaining post-quantum security through physical non-determinism and deterministic metadata governance.

At block 801, an input dataset is received. The input dataset may include binary files, structured or semi-structured data (e.g., JSON, XML), or unstructured data such as text, images, or audio bitstreams. In some implementations, the dataset is loaded into a classical memory buffer within a classical environment initialization phase where system parameters are allocated and runtime variables are instantiated.

At block 802, a non-deterministic entropy vector is obtained. The entropy vector is sourced from a non-deterministic entropy source such as a quantum random number generator (QRNG), hardware-based random noise generators, or other irreducible physical processes including thermal noise, photonic emission, or radioactive decay. In certain implementations, the entropy is streamed over a secure channel, such as a Transport Layer Security (TLS) connection, from an entropy service. The system may apply entropy source validation routines, including min-entropy threshold tests or randomness quality classifiers, to ensure the freshness and quality of the entropy vector prior to utilization.

At block 803, an entropy-conditioned transformation sequence is applied. This sequence involves recursively segmenting and non-deterministically reordering the input dataset. The non-deterministic entropy vector determines various transformation parameters, such as recursive slice boundary offsets, variable fragment length constraints, recursion depth, interleaving patterning, segment ordering, storage location, and/or integrity verification. This stage encodes structure into the data by partitioning it into entropy-weighted fragments. These fragments may be organized into structural classes such as BiBits (representing shorter, entropic, and unequal slices of binary data arrays) or OrBits (representing orthogonally rotated independent structures that are statistically independent from one another). The use of orthogonal fragments is arranged to minimize data replication and increase data consistency. In some embodiments, the transformation sequence incorporates positional rekeying and interleaving patterns derived from the entropy vector.

While entropy-driven methods are preferred for high-security applications, alternative embodiments incorporate non-entropic fractalization methods. These alternative methods may include deterministic segmentation logic, such as fixed-length partitioning or mathematical set decomposition, algorithmic structural divisions such as binary-tree segmentation or fixed-interval slicing, or artificial intelligence-driven fragment generation such as deep-learning-guided semantic segmentation. In advanced implementations, artificial intelligence models may adaptively select transformation sequences based on the modality, density, or complexity of the input data.

At block 804, deterministic metadata is generated. The metadata generator produces records that precisely capture the transformation lineage, including the entropy seed values, the fragmentation hierarchy, and the segment relationships. The metadata incorporates one or more deterministic indicators derived from entropy source identity, timestamps, fragmentation parameters, and segment hash lineage. In certain implementations, the metadata is encoded within a Reconstruction Vector Key (RVK) and may include a seed-class hash identifying the entropy source and time window, a fragmentation signature representing a cryptographic hash of the recursive slicing pattern, and a transformation digest detailing reordering keys or rotation operations. Furthermore, the system may generate modality-linked metadata structures that describe intra-fragment and inter-fragment relationships across text, audio, image, or structured numerical datasets. This metadata remains reproducible within the specific transformation context but is cryptographically non-invertible across independent sessions. The metadata artifacts are encoded into machine-readable formats such as JSON, directed acyclic graphs (DAGs), hash-linked structures, and/or any other format.

At block 805, the entropy-weighted fragments and the deterministic metadata are stored. The storage process utilizes a distributed storage broker to route fragments and metadata across classical infrastructure, such as distributed file systems, NoSQL databases, or decentralized ledgers. In some embodiments, the fragments are distributed across geographically redundant storage nodes using entropy-derived keys. The storage platform may incorporate a distributed system, distributed ledger technology (DLT) based direct acyclic graph (BlockDAG) architecture where vertices represent n-dimensional non-linear blocks. For example, fragments (e.g., BiBits and OrBits) could be stored on a Fractal Ledger, while non-confidential metadata is stored on a Nexus Ledger. Each fragment may be associated with a unique, encoded identifier such as a BI-ID or OR-ID that identifies the blocks and obfuscates the block location, coordinates, and node IP addresses from any user not possessing the required identifier. To enhance security in high-assurance enterprise or sovereign storage environments, the system may employ ephemeral entropy pools governed by destruction-on-read policies or stateless processing. These embodiments are designed to comply with GDPR fragmentation standards and NIST post-quantum transition guidelines.

At block 806, the input dataset is reconstructed. Reconstruction involves deterministically reproducing the entropy-conditioned transformation sequence by validating the deterministic metadata and the non-deterministic entropy vector. The system re-ingests the original entropy vector and cross-validates it against the retrieved metadata using fragment consensus logic. Reassembly may require a quorum-based validation from distributed storage nodes. The reconstruction engine aligns the fragments based on stored indices and performs dependency-aware merging using the recorded transformation sequence. In some implementations, an alignment engine performs deterministic graph traversal to validate the full restoration path. This process includes recomputing cryptographic hashes and entropy lineage hashes to verify integrity.

In alternative embodiments, fragment reassembly may be performed without reliance on an external metadata table or lineage graph. In such cases, fragments may carry embedded self-descriptive information, such as positional indicators, chaining identifiers, sequence checksums, or entropy tags. Reassembly is achieved by scanning and matching these internal descriptors or interpreting overlapping byte patterns and neighbor-referencing tags. Additionally, reassembly may be governed by algebraic combinations such as erasure coding, homomorphic encryption, or cryptographic secret sharing schemes. If the re-ingested entropy or the metadata fails to match expected values, the reassembly is aborted and the error is logged for audit. This process treats entropy vector validation as a structural analog to quantum measurement collapse, ensuring that only authenticated requests lead to data release.

In a first exemplary embodiment, a structured dataset is ingested and mapped into a quantum register. The system obtains a non-deterministic entropy vector from a QRNG to parameterize the depth of a quantum gate sequence. One or more Hadamard gate(s) or similar (e.g., superposition gate(s), basis-transformation gate(s), unitary mixing gate(s), rotation gate(s), or probabilistic state-transformation gate(s)) may be applied to induce superposition, followed by one or more CNOT gate(s) or similar (e.g., controlled gate(s), entanglement gate(s), conditional logic gate(s), multi-qubit correlation gate(s), or controlled unitary operation(s)) to establish multi-qubit entanglement across binary segments of the data. Upon measurement, the system observes a “Full Collapse,” where the resulting bitstring satisfies the expected entropy thresholds and entanglement signatures. The system then captures this classical bitstring and generates a deterministic reconstruction key that encodes the gate lineage and structural hashes. These classical artifacts are distributed across geographically redundant storage nodes, while the original quantum state is zeroized. During reconstruction, an alignment engine cross-validates the stored metadata against the original entropy fingerprint to permit bit-level reassembly.

In a second exemplary embodiment, the system operates on a purely classical infrastructure to secure a multimedia file. The system ingests a non-deterministic entropy vector from a physical noise source, such as thermal noise. This vector is subjected to an entropy conditioning process that maps the raw bits into specific operational parameters, including slice boundary offsets and variable fragment length constraints. The file is recursively partitioned into a plurality of entropy-weighted fragments, specifically BiBits and/or OrBits, which are then reordered using entropy-gated scrambling logic to destroy positional predictability. The system generates a Reconstruction Vector Key (RVK) that encodes the transformation path and entropy seed. Reconstruction is only authorized if the re-ingested entropy vector deterministically reproduces the original segmentation logic and matches the metadata hash lineage.

In a third exemplary embodiment, the system handles an invalid transformation event during a hybrid session. Environmental noise or a gate misfire during the quantum processing stage results in a “Partial Collapse.” The measurement produces a malformed output with incomplete entanglement signatures that fail the structural hash verification. The system classifies this as a security fault and denies the generation of a reconstruction key. Any subsequent attempt to reconstruct the data using the malformed artifacts is rejected by the reconstruction engine. This ensures that only outputs from validated, clean collapse events are admitted into the storage pipeline, thereby preventing the reassembly of corrupted or tampered data fragments.

### PRIOR ART

U.S. Pat. No. 8,554,994 (Resch) This reference describes a distributed storage network that generates data slices from original segments and stores them in memory stripes spanning multiple physical devices. It utilizes source names and unique addressing information to determine the specific storage locations for each error-coded slice across a plurality of memory devices. In contrast, the present disclosure utilizes a non-deterministic entropy source to drive recursive fractalization and employs irreversible quantum collapse to generate deterministic metadata for reassembly rather than conventional memory striping.

U.S. Pat. No. 8,700,890 (Runkis et al.) This reference details a system for parsing bit streams into datasets, compressing and encrypting them, and dispersing them across storage nodes such that a threshold of portions contains a complete bit stream. The method emphasizes accelerating transmission rates by maintaining datasets in a highly compressed state that remains indecipherable to unauthorized users. The present disclosure differs by introducing a hybrid architecture where quantum gate operations encode superposition and multi-qubit entanglement into structured quantum states representing the data prior to measurement collapse.

U.S. Pat. No. 11,755,759 (Steinberg et al.) This reference proposes securing data by creating microshard fragments smaller than a defined atomic unit of value and dispersing them across separate servers to obscure material value. It focuses on reducing the material value of single shards by intermixing them with shards from independent datasets or meaningless data. The present application diverges by utilizing quantum-optical intensity fluctuations to parameterize recursive segmentation depth and treating the irreversible collapse of quantum states as a secure boundary event for generating deterministic reconstruction keys.

U.S. Pat. No. 9,450,923 (Klum et al.) This reference describes splitting data files into pieces and placing them randomly within a diverse mesh of cloud storage providers to eliminate single points of failure. It utilizes randomized numerical codes to determine the storage location for each individual data packet while optionally encrypting the pieces. The current disclosure distinguishes itself by using an alignment engine and entropy-derived dependency vectors to validate the structural reassembly path during reconstruction without reliance on a centralized index or static mapping table.

U.S. Pat. No. 11,531,724 (Shear) This reference discloses an entity-centric database platform where data access and retrieval are bound to unique relationship identifiers (RDIDs) mapped to specific entities. It provides a domain-partitioned, schema-agnostic platform where every field is addressable through hierarchical Uniform Resource Identifiers. The present application differs by incorporating relationship identifiers into a specific transformation lineage where the identifiers facilitate the simulation of quantum transformations to regenerate structural hashes during the verification phase.

U.S. Pat. No. 11,281,660 (Pike et al.) This reference details the fractalization of transaction data into orthogonal components for storage on a distributed ledger system characterized by a bifurcated consensus mechanism. It emphasizes multi-parallel processing of n-dimensional splits to improve throughput and scalability for distributed transaction systems. Unlike the ledger-centric approach of this reference, the present application focuses on the conversion of fragile quantum-encoded states into deterministic classical representations as a secure post-quantum storage mechanism.

US 2021/0081548 (Wang) This reference proposes a fractal file encryption engine that divides confidential files into fragments and generates encrypted fragment chains that are subsequently stored in a distributed queue database. It utilizes a security chain module to provide layer-by-layer encryption for both the file fragments and their corresponding file index. The present application diverges by leveraging true physical non-determinism to dynamically parameterize slice offsets and recursive depth, ensuring that identical datasets processed in separate sessions produce structurally distinct outputs.

U.S. Pat. No. 12,229,632 (Macready et al.) This reference describes hybrid computers comprising quantum processors operated as high-entropy samplers to generate data statistics for machine learning model training. It focuses on tuning the quantum processor to match moments of the data statistics to characterize distributions for generative or discriminative models. The current application diverges by employing quantum gate sequences specifically as a cryptographic transformation layer to encode structural dependencies between data fragments prior to a deliberate measurement event.

U.S. Pat. No. 11,177,946 (Islam et al.) This reference relates to distributing quantum random numbers as a service via secure Software Defined Perimeter (SDP) connections to client devices requesting entropy. It primarily addresses the problem of entropy starvation in headless server devices by providing cryptographically secure nonces on request. The present disclosure differs by integrating quantum entropy directly into the recursive segmentation and reordering logic of a data storage architecture rather than merely distributing it as a seed for external cryptographic processes.

U.S. Pat. No. 10,019,235 (Nordholt et al.) This reference describes quantum random number generators that produce random bits based on quantum-optical intensity fluctuations from thermal sources. It utilizes signals proportional to optical intensity and delayed intensity to remove common-mode noise and classical variations from the output stream. The present application diverges by leveraging these quantum-optical fluctuations to drive the non-deterministic reordering and structural categorization of input data into entropy-weighted fragments such as BiBits and OrBits.

What is claimed is:

1. A method for secure data transformation and reconstruction, comprising:
receiving an input dataset;
applying a sequence of quantum gate operations based at least in part on a non-deterministic entropy source, the sequence of quantum gate operations configured to encode entropy, superposition, and entanglement into structured quantum states representing the input dataset;
recursively fractalizing the structured quantum states into entropy-weighted fragments;
performing a measurement operation on the structured quantum states, wherein the measurement operation irreversibly collapses the structured quantum states into deterministic classical representations;
generating a deterministic reconstruction key encoding structured metadata, the structured metadata describing transformation lineage, entropy fingerprints, and structural relationships of the deterministic classical representations, wherein the deterministic reconstruction key does not preserve quantum coherence;
storing the deterministic classical representations and the deterministic reconstruction key in a classical storage system; and
reconstructing the input dataset using classical infrastructure by validating the entropy fingerprints and the structural relationships of the structured metadata encoded in the deterministic reconstruction key.

2. The method of claim 1 wherein the recursively fractalizing the structured quantum states into entropy-weighted fragments is based at least in part on the non-deterministic entropy source.

3. The method of claim 1 wherein the entropy-weighted fragments and reconstruction key are encrypted.

4. The method of claim 1 wherein generating the deterministic reconstruction key further comprises classifying the irreversible collapsing into at least one of a full collapse, a partial collapse, or no collapse.

5. The method of claim 4 wherein reconstructing the input dataset is permitted only if the irreversible collapsing is classified as a full collapse, and wherein reconstruction is denied if classified as a partial collapse or no collapse.

6. The method of claim 1 further comprising:
performing a reconstruction integrity check to verify that the deterministic reconstruction key satisfies one or more reconstruction validation conditions sufficient to reconstruct the input dataset; and
responsive to a failure of the reconstruction integrity check, preventing release of deterministic reconstruction key.

7. The method of claim 1 wherein storing the deterministic classical representations comprises distributing the deterministic classical representations across geographically redundant classical storage nodes.

8. The method of claim 1 wherein the input dataset comprises at least of one or more datasets, invariants, capability objects, authorization structures, policy artifacts, execution constraints, or combinations thereof.

9. A method for secure data transformation and reconstruction using classical-only infrastructure, comprising:
receiving an input dataset;
obtaining a non-deterministic entropy vector;
applying an entropy-conditioned transformation sequence to the input dataset to recursively segment and non-deterministically reorder the input dataset into a plurality of entropy-weighted fragments;
generating a reconstruction key encoding deterministic metadata comprising a transformation path, an entropy seed, a structural class, and a segment fingerprint for the plurality of entropy-weighted fragments;
storing the plurality of entropy-weighted fragments and the reconstruction key across one or more classical storage systems; and
reconstructing the input dataset by deterministically reproducing the entropy-conditioned transformation sequence through validation of the deterministic metadata using the reconstruction key and the non-deterministic entropy vector.

10. The method of claim 9 wherein the non-deterministic entropy vector is obtained from a non-deterministic entropy source.

11. The method of claim 9 wherein the entropy-weighted fragments and reconstruction key are encrypted.

12. The method of claim 9 wherein the non-deterministic entropy vector determines at least one of: a slice offset, a fragment length, a recursion depth, an interleaving pattern, a segment order, a storage location, an integrity verification.

13. The method of claim 9 wherein reconstructing the input dataset is aborted if the deterministic metadata or the segment fingerprint fails to match expected values derived from the entropy-conditioned transformation sequence.

14. The method of claim 9 wherein the deterministic metadata is encoded within a reconstruction key that enables reassembly without referencing a centralized index or external mapping table.

15. The method of claim 9 wherein reconstructing the input dataset further comprises validating the deterministic metadata by recomputing cryptographic hashes and entropy lineage hashes.

16. A system for entropy-conditioned data fractalization and reconstruction, comprising:
an entropy ingestion module configured to receive a non-deterministic entropy input from a non-deterministic entropy source;
a fractalization engine configured to recursively segment and non-deterministically order input data into a plurality of fragments based on parameters derived from the non-deterministic entropy input;
a metadata generator configured to generate a deterministic reconstruction key comprising metadata that encodes a transformation pathway, structural dependencies, and an entropy fingerprint associated with the plurality of fragments;
a storage controller configured to route the plurality of fragments and the deterministic reconstruction key to one or more classical storage locations; and
a reconstruction engine configured to reconstruct the input data by cross-validating the deterministic reconstruction key against the non-deterministic entropy input, wherein any mismatch causes the reconstruction to abort.

17. The system of claim 16 wherein the fractalization engine operates in at least one of (i) a hybrid quantum-classical mode and applies quantum gate operations to encode the non-deterministic entropy input into quantum states prior to inducing an irreversible measurement collapse, and (ii) a classical-only mode and applies the parameters derived from the non-deterministic entropy input without utilizing quantum gate operations.

18. The system of claim 16 wherein the metadata generator is configured to produce hash-linked metadata graphs and quantum dependency vectors.

19. The system of claim 16 wherein the storage controller dynamically determines storage distribution paths using the non-deterministic entropy input to avoid fixed or user-defined endpoint assignments.

20. The system of claim 16 wherein at least one of the non-deterministic entropy input, the input data, the plurality of fragments, one or more ephemeral encryption keys, one or more entropy-derived cryptographic artifacts, one or more stateless encryption materials, one or more ingredient-sharing materials, the deterministic reconstruction key, the metadata, or the one or more classical storage locations are zeroized from memory immediately upon completion of any data transformation or reconstruction.
